(19) United States
(12) Patent Application Publication
(10) Pub. No.: US 2022/0118292 A1
(43) Pub. Date: Apr. 21, 2022

(54) MASK WITH SEWN-IN FILTER, LANYARD AND ADJUSTABLE EAR STRAP

(71) Applicant: Remasque, LLC, Rolling Hills, CA (US)

(72) Inventors: KHUSHBOO KAMARA SAREEN, Rolling Hills, CA (US); RAJ SAREEN, Rolling Hills, CA (US); RAM SAREEN, Rolling Hills, CA (US)

(73) Assignee: Remasque, LLC, Rolling Hills, CA (US)

(21) Appl. No.: 17/484,880

(22) Filed: Sep. 24, 2021

Related U.S. Application Data
(60) Provisional application No. 63/083,020, filed on Sep. 24, 2020.

(51) Int. Cl. A62B 18/08; A41D 13/11; A62B 23/02

(52) U.S. Cl. CPC A62B 18/08; A62B 23/025; A41D 13/1161

(57) ABSTRACT

A mask comprises a face cover portion having a front panel and a rear panel, with a nanofiltration panel sewn in between the front panel and the rear panel, a left adjustable ear strap, a right adjustable ear strap, and a lanyard allowing the mask to hang from a user's neck while the left and right adjustable ear straps are disengaged from ears of the user.

### FIELD OF THE INVENTION

The invention relates to a mask with a sewn-in filter. More specifically, a mask has a sewn-in filter, lanyard and adjustable ear strap.

### BACKGROUND OF THE INVENTION

For the purpose of illustrating the invention, there is shown in the accompanying drawings several embodiments of the invention. However, it should be understood by those of ordinary skill in the art that the invention is not limited to the precise arrangements and instrumentalities shown therein and described below.

At the time of filing this application, the COVID19 pandemic is in full effect around the world, and health organizations everywhere recommend, or require, the wearing of masks that at least cover a person's mouth and nose. However, as mask wearing recommendations are followed, miscommunication has become an issue, especially in critical environments such as in the medical and emergency professions, for example. As another example, the potential for miscommunication may be especially compounded in deaf and hard of hearing medical patients when standard face masks, such as a surgical mask, are used. It is estimated that approximately 55% of communication is nonverbal. Standard masks block the wearer's face and prevent the ability of others to see facial expressions and read lips of the mask wearer. Implementations of the disclosed subject matter may provide a mask with full-face visibility. The mask may provide protection, and may provide comfort and breathability to the wearer. The face mask of the disclosed subject matter may allow patients and other individuals to see more of the wearer's face and facial expressions, while the mask may provide safety, comfort, and breathability to the wearer.

Although many people may benefit from whole face communication, it may be especially important for: deaf and hard of hearing patients, medical staff, medical students, laboratory technicians, and scientists; limited English Proficiency patients; sign language interpreters and agencies; dentists, dental hygienists, and other dental health professionals; patients prone to or experiencing stress and anxiety; paediatric patients; immunosuppressed patients; cancer patients; HIV/AIDS patients; organ transplant recipients; medical staff who cannot receive seasonal flu vaccinations and must wear masks; and all medical staff so that they can see their colleagues' faces and better understand dialogue in dental and/or medical environments, such as an operating room, and/or in noisy environments. People in non-medical settings that use face masks may also benefit from whole face communication.

### SUMMARY OF THE INVENTION

In accord with an aspect of a preferred embodiment, a mask comprises a face cover portion having a front panel and a rear panel, with a nanofiltration panel sewn in between the front panel and the rear panel, a left adjustable ear strap, a right adjustable ear strap, and a lanyard allowing the mask to hang from a user's neck while the left and right adjustable ear straps are disengaged from ears of the user.

In accord with another aspect of a preferred embodiment, a method for manufacturing a mask comprises: cutting a front panel and a rear panel from cloth of a face cover; cutting a nanofiltration panel sized for fitting between the front and rear panels; sewing the nanofiltration panel between the front and the rear panels to form the face cover; sewing a left adjustable ear strap to the face cover; sewing a right adjustable ear strap to the face cover; and sewing to the face cover a lanyard allowing the mask to hang from a user's neck while the left and right adjustable ear straps are disengaged from ears of the user.

### BRIEF DESCRIPTION OF THE DRAWINGS

FIG. 1 is an elevational view of the back side of the face mask according to one embodiment;

FIG. 2 is a back elevational view of a face mask in an embodiment with an alternative strap;

FIG. 3 is a front elevational view of the mask according to the embodiment of FIG. 1, installed on a model's face for reference;

FIG. 4 is a rear elevational view of a mask 100 according to a non-window alternative embodiment;

FIG. 5 is a folded right-side elevational view of a mask according to the embodiment of FIG. 4; and

FIG. 6, a partial cutaway view of the layers of the face cover portion according to the embodiment of FIG. 4.

### DETAILED DESCRIPTION OF THE PREFERRED EMBODIMENTS

Implementations of the disclosed subject matter may include a mask having a transparent viewing area. In some implementations, the viewing area may be translucent, opaque, or the like. The transparent viewing area may be coated with an anti-fog or fog-resistant coating to provide full-face visibility. The mask may include features that provide for comfort and breathability.

Implementations of the disclosed subject matter may provide a face mask having a transparent plastic piece and/or extended plastic piece. The plastic piece may provide improved visibility to whole face of the user of the face mask, such that others may observe the full facial expressions and/or lip movements of-the user. The plastic piece may act as an impermeable barrier for air and/or other particulates and may provide increased protection compared to conventional face masks only made from cloth-like or papers materials.

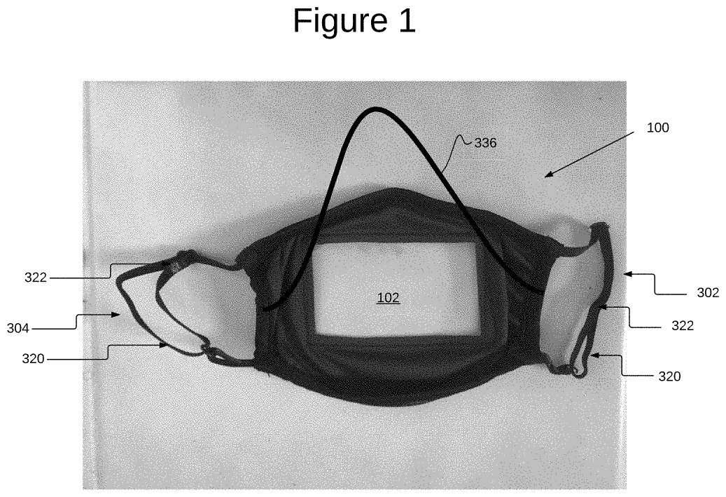

FIGS. 1-3 show views of a face mask 100 according to implementations of the disclosed subject matter. In particular, FIG. 1 shows a view of the back side of the face mask 100. In one embodiment, the face mask 100 has adjustable straps 402 that form first and second loops with ends attached to the face mask 100.

The face mask 100 may include a transparent plastic piece 102 having a front side, a back side, a top side, a bottom side, a left side, and a right side. The transparent plastic piece 102 may, in some implementations, include an extension above the mask 100. The extension may cover the eyes and/or upper head region of a user. In some implementations, the viewing area of the transparent plastic piece 102 and/or extension may be translucent, opaque, or the like. The transparent viewing area of the transparent plastic piece 102 and/or extension may be coated with an anti-fog or fog-resistant coating to provide full-face visibility, where the coating may prevent the condensation of water in the form of small droplets on a surface of the mask which resemble fog. That is, the anti-fog or fog-resistant coating may minimize moisture collection (e.g., from the breath of a wearer of the face mask 100) on the back side of the transparent plastic piece and/or extension.

At least one first strap 302 may have an adjustment loop 320 and buckle 322 to allow adjustability of the strap to fit around the user's ear. Similarly, the second strap 304 may have an adjustment loop 320 and buckle 322 to allow adjustability of the strap to fit around the user's ear. In addition, a necklace strap 336 may be included and attached to the mask to allow for the mask to hang down on a user's chest or below the user's neck when the straps 302 and 304 are off of the ears of the user.

The ends of the straps 302 and 304 may be affixed to the mask 100 using an adhesive, by bonding, by using ultrasonic welding, stitching, or any other suitable method. The first strap 302 and the second strap 304 may be formed of a fabric, such as a woven fabric or a knitted fabric, and/or any other suitable material. In some implementations, the fabric may include elastic material, or may be elastic.

The non-windowed fabric portion of the mask may be made of bamboo, providing for fabric softness, moisture wicking, and odour-fighting properties, which is a significant improvement over cotton. In one embodiment, the clear windowed portion 102 may be stitched or insertable within the cloth portion in a manner sufficient to protect the wearer from particulates or bacteria from entering the face mask 100 on the side.

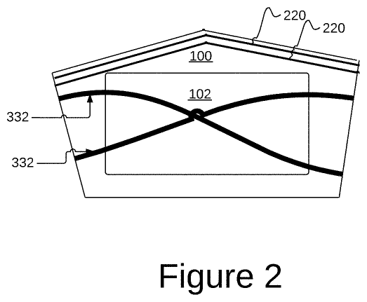

With reference to FIG. 2, an embodiment with an alternative strap system is shown. In the embodiment of the mask 100 in FIG. 2, instead of ear straps, neck straps 322 are provided. The neck straps 332 may have elasticity to stretch over the user's head, to retract in a criss-cross pattern around the user's neck when fitted in place.

In addition, in one embodiment, the cloth portion outside the clear window portion may comprise two layers with the window portion 102 sewn in between as a way construction of the mask 100. In in embodiment, a pouch added behind the outer back layer of the mask 100 may allow for in insertable filter, wherein the filter may have a window cut-out the size of the clear window portion 102 so as not to obstruct the view through the window. In one embodiment, the interchangeable filters may be MERV-16 rated filters for 95% filtering efficiency. The filter may be made of a nano fiber textile that is electro-spun and is made of FDA approved polypropylene.

The mask 100 may use an advanced moister control system. A combination of fabrics that help to both repel moister from entering the mask, and absorbs moister from within the mask, and releases the moister quickly, keeping the mask as dry as possible as well as making it easy to wash and dry quickly.

A flexible nose bridge may use double boning. Normally, single boning in a mask comprises a single metal or plastic wire sewn within the material that is bendable and holds shape, for example, around the bridge of the user's nose during use. Using two bones 220 within material between the outer and inner layers of the mask 100 allows for more efficient holding of the shape.

With regard to moister, the outer layer uses poly-blended polyester fabrics with a natural inherent ability to repel moister, while the inside layer uses bamboo fabric, which has a natural ability to absorb and release moister quickly. Thus, the mask 100 uses a moister wicking fabric on the inside and a poly-blend on the outside, or combination of other materials to accomplish the same purpose. However, the use of bamboo is eco-friendly as a material for construction of the mask.

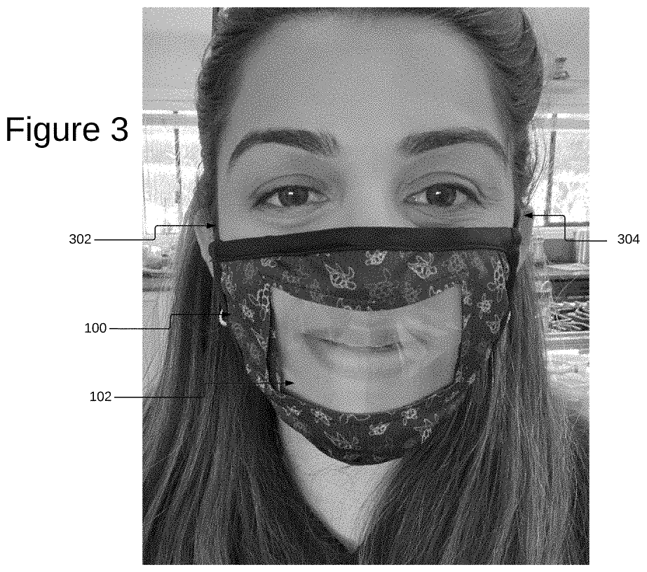

With reference to FIG. 3, a view of the mask 100 according to the embodiment of FIG. 1 is shown, installed on a person's face for reference. As shown, the bottom part of the user's face can be seen through the window 102.

In one embodiment, fabric for the mask 100 is laser cut so that yield is maximized using a 2-dimensional geometric minimization algorithm to minimize fabric waste during cutting.

The mask may be customized with logos using a digital printer. The front or back may have a singular logo or a logo printed and positioned as step-and-repeat in any desired size.

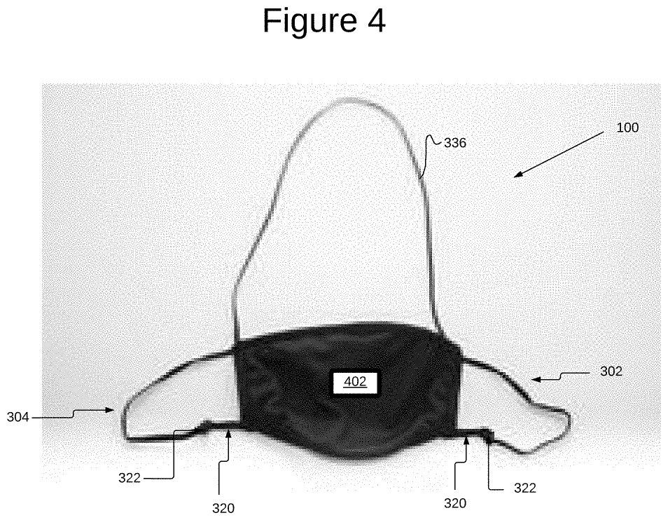

With reference to FIG. 4, a rear elevational view of a mask 100 according to a non-window alternative embodiment is shown. In the alternative embodiment, instead of a window, a nanofiltration layer (nano-filter) is sewn into the entirety of the face cover 402 portion of the mask 100. For example, nanofiltration uses a membrane filtration-based method that uses nanometer sized through-pores that pass through the membrane. Nanofiltration membranes have pore sizes from 1-10 nanometers, which is smaller than that used in microfiltration and ultrafiltration.

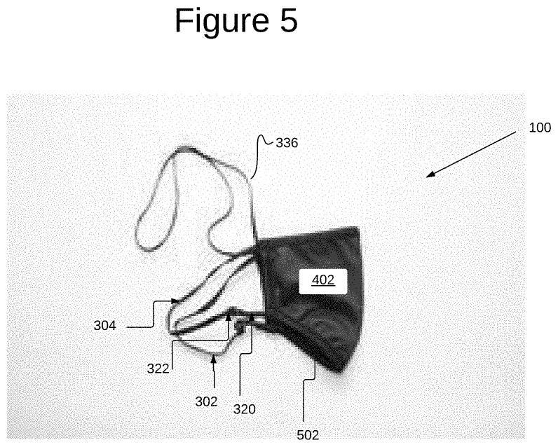

With reference to FIG. 5, a folded right-side elevational view of a mask 100 is shown. On the edges of the face cover 402, the stitching can be show that encloses the non-filter layer.

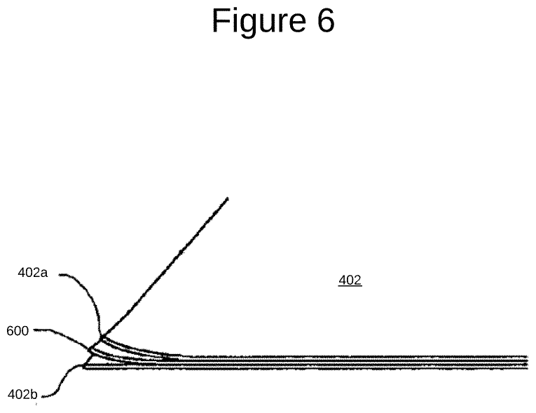

With reference to FIG. 6, a partial cutaway view of the layers of the face cover portion 402 is shown. The front panel 402a of the face cover 402 is sew to the rear panel 402b but with the nano-filter 600 in between so that the nano-filter remains enclosed within the face cover 402.

The foregoing description, for purpose of explanation, has been described with reference to specific implementations. However, the illustrative discussions above are not intended to be exhaustive or to limit implementations of the disclosed subject matter to the precise forms disclosed. Many modifications and variations are possible in view of the above teachings. The implementations were chosen and described in order to explain the principles of implementations of the disclosed subject matter and their practical applications, to thereby enable others skilled in the art to utilize those implementations as well as various implementations with various modifications as may be suited to the particular use contemplated.

The various embodiments described above are provided by way of illustration only and should not be construed to limit the invention. Those skilled in the art will readily recognize various modifications and changes that may be made to the claimed invention without following the example embodiments and applications illustrated and described herein, and without departing from the true spirit and scope of the claimed invention, which is set forth in the following claims.

What is claimed is:

1. A mask comprising:
a face cover portion having a front panel and a rear panel;
a nanofiltration panel sewn in between the front panel and the rear panel;
a left adjustable ear strap;
a right adjustable ear strap; and
a lanyard allowing the mask to hang from a user's neck while the left and right adjustable ear straps are disengaged from ears of the user.

2. The mask of claim 1, further comprising a clear window portion cut and sewn into the mask to allow for viewing of a user's lips.

3. A method for manufacturing a mask comprising:
cutting a front panel and a rear panel from cloth of a face cover;
cutting a nanofiltration panel sized for fitting between the front and rear panels;
sewing the nanofiltration panel between the front and the rear panels to form the face cover;
sewing a left adjustable ear strap to the face cover;
sewing a right adjustable ear strap to the face cover; and
sewing to the face cover a lanyard allowing the mask to hang from a user's neck while the left and right adjustable ear straps are disengaged from ears of the user.

4. The method of claim 3, further comprising cutting and sewing a clear window portion into the mask to allow for viewing of a user's lips.
